(19) United States
(12) Patent Application Publication
(10) Pub. No.: US 2010/0176052 A1
(43) Pub. Date: Jul. 15, 2010

(54) PROCESS FOR PRODUCING COMPOSITE SEMIPERMEABLE MEMBRANE

(75) Inventors: Atsuhito Koumoto, Osaka (JP); Takashi Kamada, Osaka (JP); Tomomi Ohara, Osaka (JP)

Correspondence Address: KNOBBE MARTENS OLSON & BEAR LLP, 2040 MAIN STREET, FOURTEENTH FLOOR, IRVINE, CA, 92614, US

(73) Assignee: NITTO DENKO CORPORATION a corporation

(21) Appl. No.: 12/593,844

(22) PCT Filed: Mar. 27, 2008
(86) PCT No.: PCT/JP2008/055847

§ 371 Date: Mar. 8, 2010

(30) Foreign Application Priority Data
Mar. 30, 2007 (JP) 2007-092861

(51) Int. Cl. C02F 1/28; B05D 3/00

(52) U.S. Cl. 210/500.38; 427/299

(57) ABSTRACT

The present invention aims at providing a process for producing composite semipermeable membrane excellent in water permeability and salt-blocking rate, and including an extremely small amount of unreacted components in the membrane, and at providing a composite semipermeable membrane obtained by the production process. The present invention relates to a process for producing a composite semipermeable membrane, comprising the steps of: producing an unwashed composite semipermeable membrane by forming a skin layer including a polyamide resin obtained by reaction between a polyfunctional amine component and a polyfunctional acid halide component on the surface of a porous support; and pretreating the unwashed composite semipermeable membrane by contact to a solution containing a water-soluble alcohol, and subsequently performing a membrane washing treatment by contact to pure water or ion exchange water.

### FIELD OF THE INVENTION

The present invention relates to a process for producing a composite semipermeable membrane having a skin layer which includes a polyamide resin and a porous support that supports the skin layer. The composite semipermeable membranes are suitably used for production of ultrapure water, desalination of brackish water or sea water, etc., and usable for removing or collecting pollution sources or effective substances from pollution, which causes environment pollution occurrence, such as dyeing drainage and electrodeposition paint drainage, leading to contribute to closed system for drainage. Furthermore, the membrane can be used for concentration of active ingredients in foodstuffs usage, for an advanced water treatment, such as removal of harmful component in water purification and sewage usage etc.

### DESCRIPTION OF THE RELATED ART

Recently, many composite semipermeable membranes, in which a skin layer includes polyamides obtained by interfacial polymerization of polyfunctional aromatic amines and polyfunctional aromatic acid halides and is formed on a porous support, have been proposed (Patent documents 1 to 4). A composite semipermeable membrane, in which a skin layer includes a polyamide obtained by interfacial polymerization of a polyfunctional aromatic amine and a polyfunctional alicylic acid halide and is formed on a porous support, has been also proposed (Patent document 5).

However, when it is needed to obtain a target compound condensed or refined as permeated liquid or non-permeated liquid using conventional semipermeable membranes in actual cases, there has occurred problems that unreacted components eluted or flowing out from parts constituting the membrane or the membrane module may reduce purity of the targeted compound. In order to solve with this problem, sufficient washing is given to these semipermeable membranes and membrane modules in advance of use, but this washing operation generally may take long time or need high energy and, may reduce membrane performances, such as flux of the membrane.

There have been proposed a process of processing the membrane with a solution of sodium hydrogensulfite of 0.01 to 5% by weight, at a temperature from approximately 20 to 100° C., for approximately 1 to 60 minutes in order to remove unreacted components from the semipermeable membrane (Patent document 6), a process of removing unreacted residual materials by contact of an organic material aqueous solution to a composite semipermeable membrane (Patent document 7), and a process of extracting excessive components remaining in the base material by successive bath of citric acid, bleaching agents, and the like (Patent document 8).

On the other hand, a membrane separation process, in which filtration of a water to be treated is accompanied by concurrent ultrasonic cleaning of the membrane element in order to separate and remove solid matters that are attached to the film surface of the membrane element and cannot be easily released and pollution in fine pores, and to prevent solid matters from attaching on the film surface (Patent document 9).

A process of manufacturing a fluid separation membrane, in which unreacted aromatic monomers can be removed by washing with a cleaning liquid at a temperature of 50° C. or more, has been proposed (Patent document 10). Furthermore, a process for producing a liquid separation membrane is disclosed, wherein a separation membrane is contacted to a solution containing a water soluble organic substance, and subsequently the separation membrane is contacted to an aqueous solution containing an acidic substance (Patent document 11).

However, there have occurred problems that conventional washing treatment methods generate a residue of a cleaning agent between the skin layer and the porous support, and causes a film defect, thereby reducing membrane performances (especially salt-blocking rate) in the case of using a hydrophobic porous support.

Patent document 1: Japanese Patent Application Laid-Open No. 55-147106

Patent document 2: Japanese Patent Application Laid-Open No. 62-121603

Patent document 3: Japanese Patent Application Laid-Open No. 63-218208

Patent document 4: Japanese Patent Application Laid-Open No. 02-187135

Patent document 5: Japanese Patent Application Laid-Open No. 61-42308

Patent document 6: U.S. Pat. No. 2,947,291 specification

Patent document 7: Japanese Patent Application Laid-Open No. 2000-24470

Patent document 8: Published Japanese translation of a PCT application No. 2002-516743

Patent document 9: Japanese Patent Application Laid-Open No. 11-319517

Patent document 10: U.S. Pat. No. 3,525,759 specification

Patent document 11: Japanese Patent Application Laid-Open No. 2005-137964

### DISCLOSURE OF THE INVENTION

### Problems to be Solved by the Invention

The present invention aims at providing a process for producing composite semipermeable membrane excellent in water permeability and salt-blocking rate, and including an extremely small amount of unreacted components in the membrane, and at providing a composite semipermeable membrane obtained by the production process.

### Means for Solving the Problems

As a result of wholehearted investigation performed by the present inventors for attaining the above-described objectives, the inventors have found out that application of the pretreatment of a membrane by a specific solution before a membrane washing treatment can significantly reduce the content of the unreacted components in the membrane, while suppressing generation of membrane defects, and have completed the present invention.

That is, the present invention relates to a process for producing a composite semipermeable membrane, comprising the steps of: producing an unwashed composite semipermeable membrane by forming a skin layer including a polyamide resin obtained by reaction between a polyfunctional amine component and a polyfunctional acid halide component on the surface of a porous support; and

pretreating the unwashed composite semipermeable membrane by contact to a solution containing a water-soluble alcohol, and subsequently performing a membrane washing treatment by contact to pure water or ion exchange water.

In the process for producing a composite semipermeable membrane of the present invention, preceding hydrophilization of the porous support can suppress peeling in the interface of the skin layer and the porous support in the subsequent membrane washing using pure water or ion exchange water. Accordingly, generation of the membrane defects between the skin layer and the porous support may be prevented, and the unreacted components in the membrane may be removed without causing reduction of the membrane performances.

In the present invention, the water-soluble alcohol is preferably at least one kind of monohydric alcohol selected from the group consisting of methyl alcohol, ethyl alcohol, n-propyl alcohol, isopropyl alcohol, and t-butanol. There is a tendency that use of surfactants, saccharides, polyhydric alcohols, etc. may fail to provide a sufficient effect of the present invention due to comparatively higher surface tension. Furthermore, since pure water or ion exchange water is used at the time of membrane washing, it is necessary that the alcohol as a pretreatment liquid is water-soluble.

When the porous support is a wet porous support, the solution containing the water-soluble alcohol preferably has a concentration of the water-soluble alcohol of 0.1 to 90% by weight. Less than 0.1% by weight of the concentration of the water-soluble alcohol is apt to make the effect of suppression of the membrane deficit lower due to insufficient hydrophilization of the porous support. On the other hand, the concentration exceeding 90% by weight has a large influence on the membrane performances, and is apt to make the salt-blocking rate lower.

Alternatively, when the porous support is a dry porous support, the solution containing the water-soluble alcohol preferably has a concentration of the water-soluble alcohol of 5 to 90% by weight. Less than 5% by weight of the concentration of the water-soluble alcohol is apt to make the effect of suppression of the membrane deficit lower due to insufficient hydrophilization of the porous support. On the other hand, the concentration exceeding 90% by weight has a large influence on the membrane performances, and is apt to make the salt-blocking rate lower.

Furthermore, the present invention relates to a composite semipermeable membrane obtained by the production process.

### BRIEF DESCRIPTION OF THE DRAWINGS

FIG. 1 is a photograph illustrating a condition of membrane deficits of the composite semipermeable membrane of Example 1.

FIG. 2 is a photograph illustrating a condition of membrane deficits of the composite semipermeable membrane of Comparative Example 1.

### BEST MODE FOR CARRYING OUT THE INVENTION

Hereinafter, the embodiment of the present invention will be described. The process for producing the composite semipermeable membrane of the present invention comprises the steps of: producing an unwashed composite semipermeable membrane by forming a skin layer including a polyamide resin obtained by reaction between a polyfunctional amine component and a polyfunctional acid halide component on the surface of a porous support; and

pretreating the unwashed composite semipermeable membrane by contact to a solution containing a water-soluble alcohol, and subsequently performing a membrane washing treatment by contact to pure water or ion exchange water.

The polyfunctional amine component is defined as a polyfunctional amine having two or more reactive amino groups, and includes aromatic, aliphatic, and alicylic polyfunctional amines.

The aromatic polyfunctional amines include, for example, m-phenylenediamine, p-phenylenediamine, o-phenylenediamine, 1,3,5-triamino benzene, 1,2,4-triamino benzene, 3,5-diaminobenzoic acid, 2,4-diaminotoluene, 2,6-diaminotoluene, N,N′-dimethyl-m-phenylenediamine, 2,4-diaminoanisole, amidol, xylylene diamine etc.

The aliphatic polyfunctional amines include, for example, ethylenediamine, propylenediamine, tris(2-aminoethyl)amine, n-phenylethylenediamine, etc.

The alicylic polyfunctional amines include, for example, 1,3-diaminocyclohexane, 1,2-diaminocyclohexane, 1,4-diaminocyclohexane, piperazine, 2,5-dimethylpiperazine, 4-aminomethyl piperazine, etc.

These polyfunctional amines may be used independently, and two or more kinds may be used in combination. In order to obtain a skin layer having a higher salt-blocking property, it is preferred to use the aromatic polyfunctional amines.

The polyfunctional acid halide component represents polyfunctional acid halides having two or more reactive carbonyl groups.

The polyfunctional acid halides include aromatic, aliphatic, and alicylic polyfunctional acid halides.

The aromatic polyfunctional acid halides include, for example trimesic acid trichloride, terephthalic acid dichloride, isophthalic acid dichloride, biphenyl dicarboxylic acid dichloride, naphthalene dicarboxylic acid dichloride, benzenetrisulfonic acid trichloride, benzenedisulfonic acid dichloride, chlorosulfonyl benzenedicarboxylic acid dichloride etc.

The aliphatic polyfunctional acid halides include, for example, propanedicarboxylic acid dichloride, butane dicarboxylic acid dichloride, pentanedicarboxylic acid dichloride, propane tricarboxylic acid trichloride, butane tricarboxylic acid trichloride, pentane tricarboxylic acid trichloride, glutaryl halide, adipoyl halide etc.

The alicylic polyfunctional acid halides include, for example, cyclopropane tricarboxylic acid trichloride, cyclobutanetetracarboxylic acid tetrachloride, cyclopentane tricarboxylic acid trichloride, cyclopentanetetracarboxylic acid tetrachloride, cyclohexanetricarboxylic acid trichloride, tetrahydrofurantetracarboxylic acid tetrachloride, cyclopentanedicarboxylic acid dichloride, cyclobutanedicarboxylic acid dichloride, cyclohexanedicarboxylic acid dichloride, tetrahydrofuran dicarboxylic acid dichloride, etc.

These polyfunctional acid halides may be used independently, and two or more kinds may be used in combination. In order to obtain a skin layer having higher salt-blocking property, it is preferred to use aromatic polyfunctional acid halides. In addition, it is preferred to form a cross linked structure using polyfunctional acid halides having trivalency or more as at least a part of the polyfunctional acid halide components.

Furthermore, in order to improve performance of the skin layer including the polyamide resin, polymers such as polyvinyl alcohol, polyvinylpyrrolidone, and polyacrylic acids etc., and polyhydric alcohols, such as sorbitol and glycerin may be copolymerized.

The porous support for supporting the skin layer is not especially limited as long as it has a function for supporting the skin layer, and usually ultrafiltration membrane having micro pores with an average pore size approximately 10 to 500 angstroms may preferably be used. Materials for formation of the porous support include various materials, for example, polyarylether sulfones, such as polysulfones and polyether sulfones; polyimides; polyvinylidene fluorides; etc., and polysulfones and polyarylether sulfones are especially preferably used from a viewpoint of chemical, mechanical, and thermal stability. The thickness of this porous support is usually approximately 25 to 125 μm, and preferably approximately 40 to 75 μm, but the thickness is not necessarily limited to them. The porous support may be reinforced with backing by cloths, nonwoven fabric, etc. Here, the porous support may give a dried porous support by drying with heating, and may give a wet porous support without drying.

Processes for forming the skin layer including the polyamide resin on the surface of the porous support is not in particular limited, and any publicly known methods may be used. For example, the publicly known methods include an interfacial condensation method, a phase separation method, a thin film application method, etc. The interfacial condensation method is a method, wherein an amine aqueous solution containing a polyfunctional amine component, an organic solution containing a polyfunctional acid halide component are forced to contact together to form a skin layer by an interfacial polymerization, and then the obtained skin layer is laid on a porous support, and a method wherein a skin layer of a polyamide resin is directly formed on a porous support by the above-described interfacial polymerization on a porous support. Details, such as conditions of the interfacial condensation method, are described in Japanese Patent Application Laid-Open No. 58-24303, Japanese Patent Application Laid-Open No. 01-180208, and these known methods are suitably employable.

In the present invention, a method is especially preferable in which a covering layer of aqueous solution made from the amine aqueous solution containing a polyfunctional amine component is formed on the porous support, and subsequently an interfacial polymerization is performed by contact of an organic solution containing a polyfunctional acid halide component with the covering layer of aqueous solution, and then a skin layer is formed.

In the interfacial polymerization method, although the concentration of the polyfunctional amine component in the amine aqueous solution is not in particular limited, the concentration is preferably 0.1 to 5% by weight, and more preferably 0.5 to 2% by weight. Less than 0.1% by weight of the concentration of the polyfunctional amine component may easily cause defect such as pinhole in the skin layer, leading to tendency of deterioration of salt-blocking property. On the other hand, the concentration of the polyfunctional amine component exceeding 5% by weight allows easy permeation of the polyfunctional amine component into the porous support to be an excessively large thickness and to raise the permeation resistance, likely giving deterioration of the permeation flux.

Although the concentration of the polyfunctional acid halide component in the organic solution is not in particular limited, it is preferably 0.01 to 5% by weight, and more preferably 0.05 to 3% by weight. Less than 0.01% by weight of the concentration of the polyfunctional acid halide component is apt to make the unreacted polyfunctional amine component remain, to cause defect such as pinhole in the skin layer, leading to tendency of deterioration of salt-blocking property. On the other hand, the concentration exceeding 5% by weight of the polyfunctional acid halide component is apt to make the unreacted polyfunctional acid halide component remain, to be an excessively large thickness and to raise the permeation resistance, likely giving deterioration of the permeation flux.

The organic solvents used for the organic solution is not especially limited as long as they have small solubility to water, and do not cause degradation of the porous support, and dissolve the polyfunctional acid halide component. For example, the organic solvents include saturated hydrocarbons, such as cyclohexane, heptane, octane, and nonane, halogenated hydrocarbons, such as 1,1,2-trichlorofluoromethane, etc. They are preferably saturated hydrocarbons having a boiling point of 300° C. or less, and more preferably 200° C. or less. These organic solvents may be used independently, and two or more kinds may be used in combination.

Various kinds of additives may be added to the amine aqueous solution or the organic solution in order to provide easy film production and to improve performance of the composite semipermeable membrane to be obtained. The additives include, for example, surfactants, such as sodium dodecylbenzenesulfonate, sodium dodecyl sulfate, and sodium lauryl sulfate; basic compounds, such as sodium hydroxide, trisodium phosphate, triethylamine, etc. for removing hydrogen halides formed by polymerization; acylation catalysts; compounds having a solubility parameter of 8 to 14 (cal/cm³)^{1/2} described in Japanese Patent Application Laid-Open No. 08-224452.

The period of time after application of the amine aqueous solution until application of the organic solution on the porous support depends on the composition and viscosity of the amine aqueous solution, and on the pore size of the surface layer of the porous support, and it is preferably 15 seconds or less, and more preferably 5 seconds or less. Application interval of the solution exceeding 15 seconds may allow permeation and diffusion of the amine aqueous solution to a deeper portion in the porous support, and possibly cause a large amount of the residual unreacted polyfunctional amine components in the porous support. In this case, removal of the unreacted polyfunctional amine component that has permeated to the deeper portion in the porous support is probably difficult even with a subsequent membrane washing treatment. Excessive amine aqueous solution may be removed after covering by the amine aqueous solution on the porous support.

In the present invention, after the contact with the covering layer of aqueous solution and the organic solution including the amine aqueous solution, it is preferred to remove the excessive organic solution on the porous support, and to dry the formed membrane on the porous support by heating at a temperature of 70° C. or more, forming the skin layer. Heat-treatment of the formed membrane can improve the mechanical strength, heat-resisting property, etc. The heating temperature is more preferably 70 to 200° C., and especially preferably 100 to 150° C. The heating period of time is preferably approximately 30 seconds to 10 minutes, and more preferably approximately 40 seconds to 7 minutes.

The thickness of the skin layer formed on the porous support is not in particular limited, and it is usually approximately 0.05 to 2 μm, and preferably 0.1 to 1 μm.

In the present invention, the unwashed composite semipermeable membrane produced by the process described above is pretreated by contact to the solution containing the water-soluble alcohol, and then is subjected to a membrane washing treatment by contact to pure water or ion exchange water.

The above described water-soluble alcohol is not especially limited as long as it is an alcohol that can hydrophilized the porous support, and for example, monohydric alcohols, such as methyl alcohol, ethyl alcohol, n-propyl alcohol, isopropyl alcohol, and t-butanol; polyhydric alcohols, such as ethylene glycol, triethylene glycol, and glycerin may be mentioned. These may be used independently, and two or more kinds may be used in combination. Of these alcohols, monohydric alcohols having a comparatively smaller surface tension may preferably be used.

Solvents for dissolving the water-soluble alcohol is not especially limited as long as it does not reduce the membrane performances, and, for example, distilled water, ion exchange water, hydrocarbon solvents, etc. may be mentioned. Distilled water or ion exchange water may be especially preferably used. Here, additives may be suitably added to the solution.

The concentration of the water-soluble alcohol in the solution may suitably be adjusted while taking the hydrophobicity degree of the porous support, the drying temperature in skin layer formation, and the amount of the hydrophilic component in the porous support into consideration. In the case of using the wet porous support, the concentration of the water-soluble alcohol is preferably 0.1 to 90% by weight, more preferably 0.5 to 30% by weight, and especially preferably 0.5 to 15% by weight. Use of the wet porous support can provide a sufficient effect of hydrophilization even with a lower concentration of the water-soluble alcohol. On the other hand, in the case of using the dry porous support, the concentration of the water-soluble alcohol is preferably 5 to 90% by weight, more preferably 10 to 80% by weight, and especially preferably 10 to 60% by weight.

Although the temperature of the solution containing the water-soluble alcohol in particular will not be limited as long as the solution is in a temperature allowing existence as a liquid, form a viewpoint of easiness of treatment, and the temperature is preferably 10 to 90° C. The higher temperature of the solution provides the hydrophilization effect of the porous support, and makes hydrophilization possible at lower concentrations, leading to reduction of disposal costs and waste fluid costs. In the case of using the wet porous support, the temperature is preferably 15 to 90° C., and especially preferably 20 to 90° C. in order to promote the hydrophilization. On the other hand, in the case of using the dry porous support, the temperature is preferably 20 to 90° C., and especially preferably 30 to 90° C. in order to promote the hydrophilization.

The contact period of time of the unwashed composite semipermeable membrane with the solution containing the water-soluble alcohol in pretreatment may be suitably adjusted while taking hydrophobic degree of the porous support into consideration. In the case of using the wet porous support, the contact period of time is approximately one second to one hour, preferably one second to 10 minutes, and more preferably one second to 30 seconds. On the other hand, in the case of using the dry porous support, the contact period of time is approximately one second to one hour, preferably three seconds to 10 minutes, and more preferably five seconds to one minute. The contact period of time for less than one second provides the insufficient hydrophilization effect to the porous support. On the other hand, since the hydrophilization effect of the porous support reaches equilibrium when the contact period of time exceeds one hour, there is shown a tendency for manufacturing efficiency to deteriorate.

In the pretreatment, examples of the method of contacting the solution with the unwashed composite semipermeable membrane include all methods, such as a dipping, a pressurized water flow, a spray, an application, and a showering, and the dipping and the pressurized water flow methods are preferably used in order to obtain sufficient effect of contacting.

The shape of the unwashed composite semipermeable membrane in performing the pretreatment is not limited at all. That is, unwashed composite semipermeable membranes having any possible membrane shapes such as a shape of a flat film or a shape of a spiral element can be processed.

After pretreatment, the unwashed composite semipermeable membrane is forced to contact with pure water or ion exchange water to perform a membrane washing treatment.

In the membrane washing treatment, examples of the method of contacting the unwashed composite semipermeable membrane with pure water or ion exchange water include all methods, such as a dipping, a pressurized water flow, a spray, an application, and a showering, and the dipping and the pressurized water flow methods are preferably used in order to obtain sufficient effect of contacting.

The contact period of time is not limited at all as long as it is within an allowable range of the content of the unreacted components in the composite semipermeable membrane after the membrane washing treatment and manufacturing restrictions and any period of time may be adopted. Although the contact period of time cannot necessary be specified, it is usually several seconds to tens of minutes, and preferably 10 seconds to 3 minutes. Since the amount of removals of the unreacted components reaches equilibrium, removing effect does not necessarily improve even with longer contact period of time. When the contact period of time is excessively lengthened, there is conversely shown a tendency for the membrane performance and manufacturing efficiency. Although, the contact temperature in particular will not be limited as long as pure water or ion exchange water is in a temperature range allowing existence as a liquid, from a viewpoint of removing effect of the unreacted components, of prevention of the membrane from degradation, and of easiness of treatment, etc., the contact temperature is preferably 10 to 90° C., more preferably 10 to 60° C., and especially preferably 10 to 45° C.

In the membrane washing by the pressurized water flow method, the pressure is not in particular limited, as long as the pressure in use of pure water or ion exchange water with respect to the unwashed semipermeable membrane is in a range acceptable by the unwashed composite semipermeable membrane and the physical strength of the members and the equipment for pressure application. The pressurized water flow is preferably performed at 0.1 to 10 MPa, and more preferably at 1.5 to 7.5 Mpa. The pressurized water flow at a pressure less than 0.1 Mpa shows a tendency of extending the contact period of time, in order to obtain necessary effect. And when exceeding 10 Mpa, compaction caused by the pressure is apt to decrease the permeation flux.

The shape of the unwashed composite semipermeable membrane in performing the membrane washing treatment is not limited at all. That is, unwashed composite semipermeable membranes having any possible membrane shapes such as a shape of a flat film, or a shape of a spiral element, can be processed.

The composite semipermeable membrane produced by such a producing process has excellent water permeability and salt-blocking rate, and extremely small amount of content of the unreacted components in the membrane, and therefore the permeated liquid that has been separated and refined or the target compound that has been condensed, using the composite semipermeable membrane, will have a high purity including very few impurities.

Furthermore, in order to improve salt-blocking property, water permeability, anti-oxidizing agent property, etc. of the composite semipermeable membrane, various publicly known conventional treatments may be applied to the film.

### Example

The present invention will, hereinafter, be described with reference to Examples, but the present invention is not limited at all by these Examples.

### [Evaluation and Measuring Method]

### (Measurement of Permeation Flux and Salt-Blocking Rate)

An unwashed composite semipermeable membrane and a washed composite semipermeable membrane produced with a shape of a flat film are cut into a predetermined shape and size, and are set to a cell for flat film evaluation. An aqueous solution containing NaCl of about 1500 mg/L and adjusted to a pH of 6.5 to 7.5 with NaOH was forced to contact to a supply side, and a permeation side of the membrane at a differential pressure of 1.5 Mpa at 25° C. A permeation velocity and an electric conductivity of the permeated water obtained by this operation were measured for, and a permeation flux (m³/m²·d) and a salt-blocking rate (%) were calculated. The correlation (calibration curve) of the NaCl concentration and the electric conductivity of the aqueous solution was beforehand made, and the salt-blocking rate was calculated by a following equation.

Salt-blocking rate(%)={1−(NaCl concentration[mg/L]in

permeated liquid)/(NaCl concentration[mg/L]in supply

solution)}×100

### (Measurement of Defect Numbers in Composite Semipermeable Membrane)

A composite semipermeable membrane produced with a shape of a flat film was cut into a predetermined shape and size, and was set to a cell for flat film evaluation. An aqueous solution including 100 ppm of a dyestuff (direct blue, molecular weight: 993) was forced to contact with the membrane at 25° C. by applying a 1.5 Mpa of differential pressure to a supplying side and to a transmitting side of the membrane. This operation was conducted for 10 minutes. Subsequently, the dyestuff deposited on the membrane surface was removed in the non-pressurized condition using pure water (treatment time: for 5 minutes). Subsequently, the membrane was removed from the cell, and the number of portions that had been dyed with the dyestuff (the number of deficits) was measured.

### Production Example 1

### Production of Porous Support

A dope for manufacturing a membrane containing 18% by weight of a polysulfone (produced by Solvay, P-3500) dissolved in N,N-dimethylformamide (DMF) was uniformly applied so that it might give 200 μm in thickness in wet condition on a nonwoven fabric base material. Subsequently, it was immediately solidified by immersion in water at 40 to 50° C., and DMF as a solvent was completely extracted by washing. Thus a wet porous support having a polysulfone microporous layer was produced on the nonwoven fabric base material. Furthermore, the wet porous support was dried at 120° C. for 5 minutes to obtain a dry porous support.

### Example 1

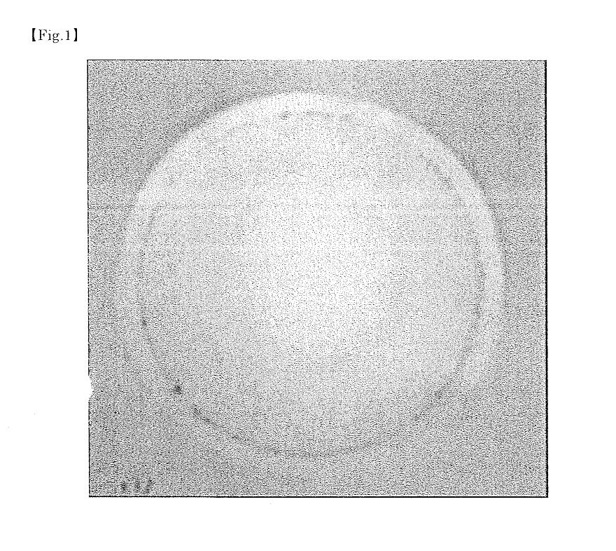

An amine aqueous solution containing 3% by weight of m-phenylenediamine, 3% by weight of triethylamine, and 6% by weight of camphorsulfonic acid was applied on the wet porous support to form a covering layer of aqueous solution. Then, an iso-octane solution containing 0.2% by weight of trimesic acid chloride was applied on the surface of the covering layer of aqueous solution. Subsequently, the covering layer of aqueous solution was maintained in a hot air drying equipment of 120° C. for 3 minutes to form a skin layer including a polyamide resin on the wet porous support, to obtain an unwashed composite semipermeable membrane. The pretreatment was performed by immersing the unwashed composite semipermeable membrane into a 5% by weight of methyl alcohol aqueous solution adjusted to 25° C. for 10 seconds. Then, the membrane washing treatment was performed by immersing the pretreated unwashed composite semipermeable membrane into pure water adjusted to 50° C. for 10 minutes to produce a composite semipermeable membrane. Table 1 shows results of permeation tests. Furthermore, FIG. 1 shows a condition of the composite semipermeable membrane after permeation of the 100 ppm dyestuff solution.

### Examples 2 to 9, and Comparative Example 2

As shown in Table 1, composite semipermeable membranes were produced by the same method as in Example 1 except that the pretreatment conditions were changed, to conduct permeation tests. Table 1 shows the results of the permeation tests.

### Comparative Example 1

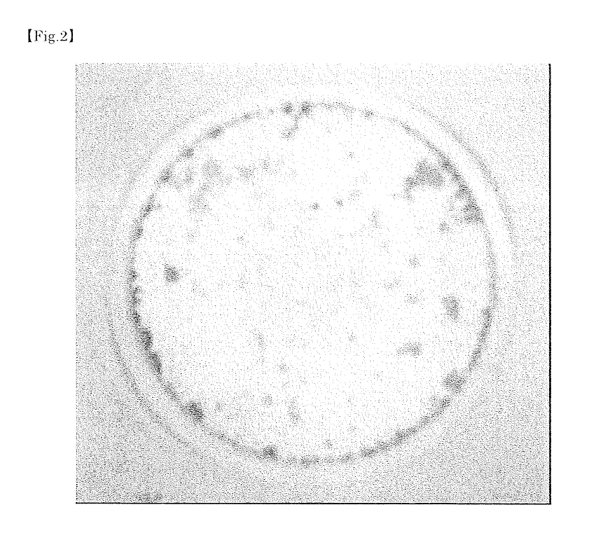

Composite semipermeable membranes were produced by the same method as in Example 1 except that the pretreatment was not carried out in Example 1, to conduct permeation tests. Table 1 shows the results of the permeation tests. Furthermore, FIG. 2 shows a condition of the composite semipermeable membrane after permeation of the 100 ppm dyestuff solution. The portion having been dyed with the dyestuff shows deficits.

### Examples 10 to 18, and Comparative Example 4

Composite semipermeable membranes were produced by the same method as in Example 1 except that a dry porous support is used instead of the wet porous support, and the pretreatment conditions were changed as described in Table 1 in Example 1, to conduct permeation tests. Table 1 shows the results of the permeation tests.

### Comparative Example 3

Composite semipermeable membranes were produced by the same method as in Example 10 except that the pretreatment was not carried out in Example 10, to conduct permeation tests. Table 1 shows the results of the permeation tests.

TABLE 1

| | | | | | Permeation test | | | | |
|---|---|---|---|---|---|---|---|---|---|
| | Pretreatment | | | | Unwashed composite | | Composite semipermeable | | |
| | | | | Treatment | semipermeable membrane | | membrane (after washing) | | |
| | | | | period of | | Permeation | | Permeation | Defect |
| | Treatment | Treatment | Concentration | time | Salt-blocking | flux | Salt-blocking rate | flux | numbers |
| | liquid | method | (% by weight) | (second) | rate (%) | (m³/m² · d) | (%) | (m³/m² · d) | (piece/cm²) |
| Example 1 | Aqueous | Immersion | 5 | 10 | 99.5 | 1.1 | 99.3 | 1.2 | 0 |
| Example 2 | solution of | | 0.5 | 10 | 99.5 | 1.1 | 99.5 | 1.0 | 0 |
| Example 3 | methyl | | 10 | 10 | 99.5 | 1.1 | 99.4 | 1.1 | 0 |
| Example 4 | alcohol | | 10 | 1 | 99.5 | 1.1 | 99.3 | 1.1 | 0 |
| Example 5 | | | 1 | 30 | 99.5 | 1.1 | 99.5 | 1.0 | 0 |
| Example 6 | | | 1 | 600 | 99.5 | 1.1 | 99.5 | 1.0 | 0 |
| Example 7 | Aqueous | | 5 | 10 | 99.5 | 1.1 | 99.2 | 1.1 | 0 |
| | solution of | | | | | | | | |
| | ethyl | | | | | | | | |
| | alcohol | | | | | | | | |
| Example 8 | Aqueous | | 5 | 10 | 99.5 | 1.1 | 99.5 | 1.2 | 0 |
| | solution of | | | | | | | | |
| | isopropyl | | | | | | | | |
| | alcohol | | | | | | | | |
| Example 9 | Aqueous | | 5 | 10 | 99.5 | 1.1 | 99.4 | 1.0 | 0 |
| | solution of | | | | | | | | |
| | n-propyl | | | | | | | | |
| | alcohol | | | | | | | | |
| Comparative | — | — | — | — | 99.5 | 1.1 | 92.8 | 1.1 | 8 |
| Example 1 | | | | | | | | | |
| Comparative | Aqueous | Immersion | 10 | 120 | 99.5 | 1.1 | 97.4 | 1.0 | 4 |
| Example 2 | solution of | | | | | | | | |
| | sodium | | | | | | | | |
| | lauryl | | | | | | | | |
| | sulfate | | | | | | | | |
| Example 10 | Aqueous | Immersion | 30 | 10 | 99.4 | 0.9 | 99.3 | 0.7 | 0 |
| Example 11 | solution of | | 10 | 10 | 99.4 | 0.9 | 99.5 | 0.8 | 0 |
| Example 12 | methyl | | 50 | 10 | 99.4 | 0.9 | 99.4 | 0.8 | 0 |
| Example 13 | alcohol | | 30 | 1 | 99.4 | 0.9 | 99.2 | 0.7 | 1 |
| Example 14 | | | 30 | 30 | 99.4 | 0.9 | 99.5 | 0.9 | 0 |
| Example 15 | | | 30 | 600 | 99.4 | 0.9 | 99.5 | 0.9 | 0 |
| Example 16 | Aqueous | | 10 | 10 | 99.4 | 0.9 | 99.2 | 0.7 | 0 |
| | solution of | | | | | | | | |
| | ethyl | | | | | | | | |
| | alcohol | | | | | | | | |
| Example 17 | Aqueous | | 10 | 10 | 99.4 | 0.9 | 99.5 | 0.9 | 0 |
| | solution of | | | | | | | | |
| | isopropyl | | | | | | | | |
| | alcohol | | | | | | | | |
| Example 18 | Aqueous | | 10 | 10 | 99.4 | 0.9 | 99.3 | 0.8 | 0 |
| | solution of | | | | | | | | |
| | n-propyl | | | | | | | | |
| | alcohol | | | | | | | | |
| Comparative | — | — | — | — | 99.4 | 1.2 | 95.4 | 0.9 | 5 |
| Example 3 | | | | | | | | | |
| Comparative | Aqueous | Immersion | 10 | 120 | 99.4 | 1.2 | 94.2 | 0.9 | 5 |
| Example 4 | solution of | | | | | | | | |
| | sodium | | | | | | | | |
| | lauryl | | | | | | | | |
| | sulfate | | | | | | | | |

From Table 1, it is found that the pretreatment of the unwashed composite semipermeable membranes with an aqueous solution containing a water-soluble alcohol and by the subsequent washing treatment of the membrane with pure water can suppress reduction of membrane performance.

1. A process for producing a composite semipermeable membrane, comprising the step of:
producing an unwashed composite semipermeable membrane by forming a skin layer including a polyamide resin obtained by reaction of a polyfunctional amine component with a polyfunctional acid halide component on the surface of a porous support; and
pretreating said unwashed composite semipermeable membrane by contact to a solution containing a water-soluble alcohol, and subsequently performing a membrane washing treatment by contact to pure water or ion exchange water.

2. The process for producing a composite semipermeable membrane according to claim 1, wherein said water-soluble alcohol is at least one kind of monohydric alcohol selected from the group consisting of methyl alcohol, ethyl alcohol, n-propyl alcohol, isopropyl alcohol, and t-butanol.

3. The process for producing a composite semipermeable membrane according to claim 1, wherein said porous support is a wet porous support, and the solution containing said water-soluble alcohol has a concentration of the water-soluble alcohol of 0.1 to 90% by weight.

4. The process for producing a composite semipermeable membrane according to claim 1, wherein said porous support is a dry porous support, and the solution containing said water-soluble alcohol has a concentration of the water-soluble alcohol of 5 to 90% by weight.

5. A composite semipermeable membrane obtained by the production process according to claim 1.

6. The process for producing a composite semipermeable membrane according to claim 1, further comprising the steps of:
after producing said unwashed composite semipermeable membrane and before pretreating said unwashed composite semipermeable membrane, removing excessive organic solution from the porous support; and
after removing excessive organic solution from the porous support and before pretreating said unwashed composite semipermeable membrane, drying the formed membrane by heating at a temperature of 70° C. or more for a time period from 30 seconds to 10 minutes.

7. The process for producing a composite semipermeable membrane according to claim 1, wherein said porous support is a wet porous support, and the solution containing said water-soluble alcohol has a concentration of the water-soluble alcohol of 0.5 to 15% by weight.

8. The process for producing a composite semipermeable membrane according to claim 1, wherein said porous support is a dry porous support, and the solution containing said water-soluble alcohol has a concentration of the water-soluble alcohol of 10 to 60% by weight.

9. The process for producing a composite semipermeable membrane according to claim 1, wherein said porous support is a wet porous support, and the temperature of the solution containing said water-soluble alcohol at the time of the pretreating step is 20 to 90° C.

10. The process for producing a composite semipermeable membrane according to claim 1, wherein said porous support is a dry porous support, and the temperature of the solution containing said water-soluble alcohol at the time of the pretreating step is 30 to 90° C.

11. The process for producing a composite semipermeable membrane according to claim 1, wherein said porous support is a wet porous support, and the contact period of time of the unwashed composite semipermeable membrane with the solution containing the water-soluble alcohol in pretreatment is 1 to 30 seconds.

12. The process for producing a composite semipermeable membrane according to claim 1, wherein said porous support is a dry porous support, and the contact period of time of the unwashed composite semipermeable membrane with the solution containing the water-soluble alcohol in pretreatment is 5 seconds to 1 minute.
